(19) United States
(12) Patent Application Publication
(10) Pub. No.: US 2021/0115365 A1
(43) Pub. Date: Apr. 22, 2021

(54) REMOVAL OF CONTAMINANTS USING ALKALINE EARTH METAL SILICATES

(71) Applicant: IMERTECH SAS, Paris (FR)

(72) Inventor: Andrew Mark RILEY, Cornwall (GB)

(21) Appl. No.: 16/608,615

(22) PCT Filed: Nov. 20, 2017
(86) PCT No.: PCT/EP2017/079709

§ 371 Date: Oct. 25, 2019

(30) Foreign Application Priority Data
Apr. 28, 2017 (EP) 17168679.3

(51) Int. Cl. C12H 1/044; C01B 33/24; B01J 20/10; B01J 20/28; C12H 1/07; A23L 2/72; A23L 2/80

(52) U.S. Cl. CPC C12H 1/0408; C01B 33/24; B01J 20/10; B01J 20/28059; B01J 20/28061; B01J 20/28004; A23V 2002/00; C12H 1/063; A23L 2/72; A23L 2/80; C01P 2006/12; C01P 2004/61; B01J 20/28016

(57) ABSTRACT

The present invention relates to a method of treating liquids with an alkaline earth metal silicate to reduce contaminants, a filtered liquid obtained by this method, the use of the method in the wine production process and a filter aid comprising an alkaline earth metal silicate.

### FIELD OF THE INVENTION

The present invention relates to a method of removing undesirable substances from liquids with the use of alkaline earth metal silicates. The present invention further relates to the use of a method comprising earth metal silicates in a wine production process.

### BACKGROUND OF THE INVENTION

During food agriculture and subsequent processing, liquid foodstuffs such as beverages and edible oils inevitable accumulate undesirable substances that are used in modern agriculture and food production. Removal of contaminants such as pesticides and phenolic compounds from liquid foodstuffs is an important process, as it allows safe foodstuffs to be produced whilst still utilising agents to increase crop production, such a pesticides.

It is desirable to remove contaminants from liquids in an efficient, cost effective and safe way. When considering liquid foodstuffs, it is of particular importance that the contaminants are removed to yield products with safe levels of contaminants in the foodstuff for human consumption. Any agent used in the method of contamination removal is also required to be safe to meet the food regulation standards. It is therefore desirable to provide improved and/or alternative methods to remove contaminants from liquids.

### SUMMARY OF THE INVENTION

The present invention is defined in the appended claims.

In accordance with a first aspect, there is provided a method of treating liquids to reduce contaminants comprising the steps of

a) providing a liquid to be treated, wherein the liquid contains contaminants,

b) contacting the liquid of step a) with an alkaline earth metal silicate, and

c) filtering the liquid of step b) to yield a filtered liquid,

wherein the alkaline earth metal silicate is a synthetic alkaline earth metal silicate, and wherein the contaminants are selected from pesticides, fungicides, herbicides, phenolics, a by-product of the metabolism of yeasts, a by-product of food processing and combinations thereof.

In accordance with a second aspect, there is provided a method of treating liquids to reduce contaminants comprising the steps of

a) providing a liquid to be treated, wherein the liquid contains contaminants,

b) contacting the liquid of step a) with an alkaline earth metal silicate, and

c) filtering the liquid of step b) to yield a filtered liquid,

wherein the alkaline earth metal silicate has a BET surface area in the range of 20 to 500 m²/g, and wherein the contaminants are selected from pesticides, fungicides, herbicides, phenolics, a by-product of the metabolism of yeasts, a by-product of food processing and combinations thereof.

In accordance with a third aspect, there is provided a filtered liquid obtainable from the method of the first or second aspect.

In accordance with a fourth aspect, there is provided a use of the method of the first or second aspect in a wine production process.

Certain embodiments of the present invention may provide one or more of the following advantages:
desired reduction in contaminants;
desired safety in terms of amount of contaminants in filtered liquid;
efficient method of reducing contaminants using materials that are easily removed from the liquid;
use of materials that exhibit low levels of toxicity or no toxicity;
retention of properties of the liquid such as colour and/or flavour.

The details, examples and preferences provided in relation to any particular one or more of the stated aspects of the present invention apply equally to all aspects of the present invention. Any combination of the embodiments, examples and preferences described herein in all possible variations thereof is encompassed by the present invention unless otherwise indicated herein, or otherwise clearly contradicted by context.

### BRIEF DESCRIPTION OF THE DRAWINGS

The invention will further be illustrated by reference to the following figures:

FIG. 1 is a schematic of a generalised wine making process.

FIG. 2 is a graph representing the amount of fenhexamid removed from model wine (A) and laboratory fermented wine (B) (Ex 1 and Comp Ex 1 and 2)

FIG. 3 is a graph representing the amount of 4-ethyl guaiacol removed from model wine (Ex 1 and Comp Ex 1 and 3)

FIG. 4 is a graph representing the amount of fenhexamid and iprodione removed from model wine (A) (Ex 1 and Comp Ex 1)

It is understood that the following description and references to the figures concern exemplary embodiments of the present invention and shall not be limiting the scope of the claims.

### DETAILED DESCRIPTION

There is provided a method of treating liquids to reduce contaminants. The liquid to be treated contains at least one contaminant, and the amount of contaminant is reduced in the liquid to be treated by the method of treatment according to the invention.

The liquid to be treated may be a foodstuff such as a beverage or edible oil. The liquid to be treated may be selected from wine, beer, spirits, fruit juices, vegetable juice, olive oil, palm oil, peanut oil, coconut oil, cottonseed oil, corn oil, palm oil, rapeseed oil, sesame oil, soybean oil and sunflower oil. The liquid to be treated may be wine, such as red wine, white wine and rosé.

As used herein, the term “contaminants” refers to one or more substances to be removed from the liquid to be treated by the method according to the present invention. Contaminants are undesirable additions to the liquid. Contaminants may be selected from pesticides, fungicides, herbicides, phenolics, a by-product of the metabolism of yeasts, a by-product of food processing and combinations thereof. For example, the contaminants may be selected from fenhexamid, iprodione, 4-ethyl guaiacol, 4-ethyl phenol, azoxystrobine, boscalid, benalaxyl, carbendazime, cyprodinil, dimetomorphe, fludioxinil, fluopicolide, iprovalicarb, mandipropamid, metalaxyl-M, metrafenone, myclobutanil, pyrimethanil, spiroxamine, tebuconazole, tebufenozide, triadimenol and combinations thereof. The concentration of contaminants in the liquid to be treated may be between about 0.001 mg to about 7 mg per litre of liquid, preferably between about 0.01 mg and about 5 mg per litre, preferably between about 0.05 mg and about 3 mg per litre, preferably between about 0.1 mg and about 1 mg per litre, preferably between about 0.2 mg and about 0.5 mg per litre. The present invention may be effective in treating higher amounts of contaminants in the fluid to be treated.

The amount of contaminants in the filtered liquid is less than the amount of contaminants in the liquid to be treated. The amount of contaminants is reduced from the weight of contaminants in a volume of liquid to be treated to the weight of contaminants in a volume of filtered liquid and expressed as a percentage change of weight by volume; % (w/v). In certain embodiments, the percentage reduction of contaminants using the method of the invention may be at least 1% (w/v), at least 5% (w/v), at least 10% (w/v), 20% (w/v), 30% (w/v), 40% (w/v), 50% (w/v), 60% (w/v), 70% (w/v), 80% (w/v), 90% (w/v), 95% (w/v), 98% (w/v), 99% (w/v).

As used herein, the term “alkaline earth metal silicate” refers to a silicate of the alkaline metal earth selected from beryllium, magnesium, calcium, strontium or barium. Preferably, the alkaline earth metal silicate is selected from magnesium silicate or calcium silicate. Alkaline earth metal silicates can be characterised by the ratio of contained silica to contained metal oxide. The “molar ratio” is the number of molecular weights of silica contained in the material for each molecular weight of metal oxide. The term “metasilicate” refers to a molar ratio of 1.0, while “orthosilicate” refers to a molar ratio of 0.5. The alkaline earth metal silicates described herein may have a molar ratio in the range of about 0.5 to about 4.0, for example from about 0.8 to about 3.5, for example from about 1.0 to about 3.0, for example from about 1.3 to about 2.5, for example from about 1.6 to about 2.7, for example from about 1.8 to about 2.6, for example from about 2.0 to about 2.5, for example from about 2.1 to about 2.4, for example from about 2.2 to about 2.3, for example from about 1.0 to about 2.1.

The alkaline earth metal silicate of the present invention is synthetic and/or has a high BET surface area in the range of 20 to 500 m²/g.

Alkaline earth metal silicates can be prepared in several ways. They can be precipitated from aqueous solutions of soluble alkaline earth metal salts; U.S. Pat. No. 4,612,292 teaches the precipitation of silicates having more than two molecular weights of SiO₂ for each molecular weight of alkaline earth metal oxide. They can be prepared by hydrothermal reaction of a natural diatomaceous earth and magnesia to form a slurry which is acid-treated, dewatered, washed, dried and optionally dispersed. They can be formed directly from the naturally-occurring sulfate minerals; the Kirk-Othmer Encyclopedia of Chemical Technology, Fourth Edition, Volume 3, page 915 states that barium sulfate can be reacted with silica to form barium orthosilicate:

2BaSO₄+SiO₂→Ba₂SiO₄+2SO₃

which is transformed in hot water to barium metasilicate:

Ba₂SiO₄+H₂O→BaSiO₃+Ba(OH)₂.

In certain embodiments, the alkaline earth metal silicate may be a particulate.

The particulates disclosed herein have a particle size. Particle size may be measured by any appropriate measurement technique now known to the skilled artisan or hereafter discovered. Unless otherwise stated, particle size and particle size properties, such as particle size distribution (“psd”), are measured using a Leeds and Northrup Microtrac X100 laser particle size analyzer (Leeds and Northrup, North Wales, Pa., USA), which can determine particle size distribution over a particle size range from 0.12 μm to 704 μm. The size of a given particle is the diameter of the particle. The median particle size, or d₅₀ value, is the value at which 50% of the particles have a particle diameter less than that d₅₀ value. The d₁₀ value is the value at which 10% of the particles have a particle diameter less than that d₁₀ value. The d₉₀ value is the value at which 90% of the particles have a particle diameter less than that d₉₀ value.

In certain embodiments, the alkaline earth metal silicate may have a median particle size, d₅₀, in the range of about 1 to about 20 μm, for example from about 2 to about 15 μm, for example from about 3 to about 13 μm, for example from about 4 to about 10 μm, for example from about 5 to about 8 μm, for example from about 6 to about 7 μm. The alkaline earth metal silicate may have a d₁₀ in the range of about 0.5 to about 6 μm, for example from about 1 to about 5 μm, for example from about 1.5 to about 4 μm, for example from about 2 to about 3 μm. The alkaline earth metal silicate may have a d₉₀ in the range of about 30 to about 55 μm, for example from about 35 to about 50 μm, for example from about 40 to about 45 μm, for example from about 42 to about 43 μm.

As used herein, the BET surface area, refers to the technique for calculating specific surface area of physical adsorption molecules according to Brunauer, Emmett, and Teller (“BET”) theory. BET surface area may be measured by any appropriate measurement technique now known to the skilled artisan or hereafter discovered. In one exemplary method, BET surface area is measured with a Gemini III 2375 Surface Area Analyzer, using pure nitrogen as the sorbent gas, from Micromeritics Instrument Corporation (Norcross, Ga., USA).

In certain embodiments, the alkaline earth metal silicate may have a BET surface area in the range of about 20 to about 500 m²/g, for example from about 40 to about 450 m²/g, for example from about 60 to about 400 m²/g, for example from about 80 to about 350 m²/g, for example from about 100 to about 300 m²/g, for example from about 150 to about 250 m²/g, for example from about 170 to about 230 m²/g or for example from about 180 to about 210 m²/g.

Without wishing to be bound by theory, it is believed that the high surface area of the alkaline earth metal silicate may contribute to the effective adherence to the contaminants. Once adhered to the alkaline earth metal silicate, the contaminants is able to be removed from the liquid by filtration.

The alkaline earth metal silicate may contact the liquid in various ways, such as “decanting”, “pre-coating”, “body feeding” or a combination of “decanting”, “pre-coating” and “body feeding”.

In a “decanting” method, the alkaline earth metal silicate is added to the liquid, optionally shaken, and allowed to sediment. The supernatant is then decanted from the sediment.

In a “pre-coating” method, the alkaline earth metal silicate and a filter aid is initially applied to a filter element before the liquid to be filtered is applied to the filter element. For example, pre-coating may involve preparing a slurry containing water, an alkaline earth metal silicate and a filter aid, and then introducing the slurry into a stream flowing through a filter element or septum. During the pre-coating process, a thin layer (e.g., 1.5-3.0 mm) is deposited onto the surface of the filtering element or septum. This will prevent or reduce gelatinous solids from plugging the filter element or septum during a subsequent filtration process, often providing a clearer filtrate.

In a “body feeding” method, the alkaline earth metal silicate and filter aid is introduced into a fluid to be filtered before the fluid reaches the filter element or septum. During filtration the alkaline earth metal silicate and filter aid material then follows the path of the unfiltered fluid and eventually reaches the filter element or septum. Upon reaching the filter element or septum, the added filter aid material will bind to a filter cake covering the filter element or septum. This can increase the porosity of the filter cake and may cause the filter cake to swell and thicken thereby increasing the permeability of the filter cake during filtration and possibly increasing the capacity of the filter cake. The filter cake comprises of the combined layers of filter aid material, alkaline earth metal silicate and contaminants on the surface of the septum.

Filter aids may include one or more material such as an inorganic powder or an organic fibrous material. Diatomaceous earth (DE) and natural glasses such as perlite, for example, are commonly employed as filter aids. Other minerals used as filter aids include mica, talc, bentonite, kaolin, smectite, wollastonite, and calcium carbonate. Methods of preparation of such mineral filter aids are also known (see e.g. WO 2009/067718 A1).

In certain embodiments, the alkaline earth metal silicate is used in a range of about 0.1 to about 20 g, for example from about 0.2 to about 15 g, for example from about 0.3 to about 10 g, for example from about 0.5 to about 8 g, for example from about 1 to about 6 g, for example from about 2 to about 4 g per litre of liquid to be treated.

In certain embodiments, the method of treating liquids may have one or more of the following effects:
efficient reduction of contaminants;
high reduction of contaminants;
safe reduction of contaminants;
cost-effective reduction of contaminants;
retention of properties of the liquid, such as taste and colour.

Also provided herein is a filtered liquid obtainable from the method according to the invention.

Further provided herein is the use of the method according to the invention in a wine production process.

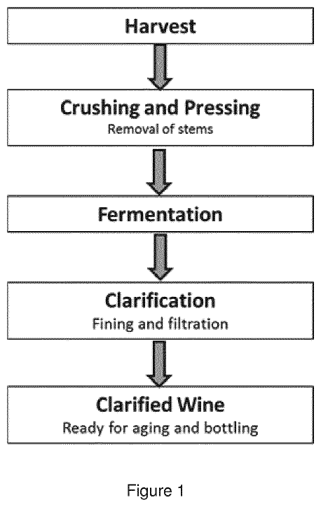

A wine production process involves many steps from the point of harvesting the grapes to obtaining the final clarified wine. The steps of a wine production process may include harvesting, crushing and pressing, fermentation, clarification, aging and bottling (See FIG. 1).

The method according to the present invention may be incorporated into a wine production process in a straightforward manner. For example, the method of the present invention may be carried out during the clarification step of the wine production process. During the clarification step, fining and filtration is carried out. Fining agents are added to the liquid to clarify the wine and increase its stability by both physical and chemical means. The fining agents are then removed by filtration. Carrying out the method of the invention during the late stage clarification process may be advantageous as no addition process step is required. Instead, the alkaline earth metal silicates may simply be added to the wine and filtered during the standard clarification step. As the clarification occurs at a late stage of the wine process, shortly before bottling there is little or no opportunity for further contaminants to enter the liquid samples.

In certain embodiments, the use of the method of the present invention a wine production process reduces contaminants associated with Brettanomyces yeast.

Microbial contamination by Brettanomyces yeast in the post-fermentation stage of wine production (i.e. during filtration of lees and storage) is a major cause of spoilage through deleterious modification of wine characteristics. Brettanomyces produces a number of volatiles associated with negative aromas typically due to vinyl and ethyl phenols such as 4-ethyl phenol and 4-ethyl guaiacol which impart odours to the contaminated wine. When the phenolics are present at levels exceeding about 0.6 mg L⁻¹, it is reported that the undesirable effects are apparent in the aroma of the wine.

In certain embodiments, the use of the method of the present invention reduces the amount of contaminants to less than about 0.6 mg L⁻¹. The amount of contaminants may also be reduced to less than about 0.5 mg L⁻¹, less than about 0.4 mg L⁻¹, less than about 0.3 mg L⁻¹, less than about 0.2 mg L⁻¹, less than about 0.1 mg L⁻¹.

Also provided herein is a filter aid comprising an alkaline earth metal silicate. The alkaline earth metal is as described herein. In addition to the alkaline earth metal, the filter aid may comprise one or more material such as an inorganic powder or an organic fibrous material, as disclosed herein.

For the avoidance of doubt, the present application is directed to subject-matter described in the following numbered paragraphs.
1. A method of treating liquids to reduce contaminants comprising the steps of
   a) providing a liquid to be treated, wherein the liquid contains contaminants,
   b) contacting the liquid of step a) with an alkaline earth metal silicate, and
   c) filtering the liquid of step b) to yield a filtered liquid,

wherein the alkaline earth metal silicate is a synthetic alkaline earth metal silicate.
2. The method of numbered paragraph 1, wherein the alkaline earth metal silicate is selected from synthetic magnesium silicates and synthetic calcium silicates.
3. The method of numbered paragraph 1 or numbered paragraph 2, wherein the alkaline earth metal silicate has a BET surface area in the range of 20 to 500 m²/g.
4. A method of treating liquids to reduce contaminants comprising the steps of
   a) providing a liquid to be treated, wherein the liquid contains contaminants,
   b) contacting the liquid of step a) with an alkaline earth metal silicate, and
   c) filtering the liquid of step b) to yield a filtered liquid,
      wherein the alkaline earth metal silicate has a BET surface area in the range of 20 to 500 m²/g.
5. The method of any one of the preceding numbered paragraphs, wherein the alkaline earth metal silicate is a particulate.
6. The method any one of the preceding numbered paragraphs, wherein the alkaline earth metal silicate has a median particle size, d₅₀, in the range 1 to 20 μm of as measured using a Microtrac X100 laser particle size analyzer.
7. The method of any preceding numbered paragraph, wherein the alkaline earth metal silicate is used in a range of about 0.1 to about 20 g per litre of liquid to be treated.
8. The method of any preceding numbered paragraph, wherein the amount of contaminants in the filtered liquid is less than in the liquid to be treated.
9. The method of any preceding numbered paragraph, wherein the amount of contaminants is reduced by between 5% (w/v) and 95% (w/v).
10. The method of any preceding numbered paragraph, wherein the liquid to be treated is a foodstuff.
11. The method of numbered paragraph 10, wherein the foodstuff is selected from a beverage or edible oil.
12. The method of numbered paragraph 10 or numbered paragraph 11, wherein the foodstuff is selected from wine, beer, spirits, fruit juices, vegetable juice olive oil, palm oil, peanut oil, coconut oil, cottonseed oil, corn oil, palm oil, rapeseed oil, sesame oil, soybean oil and sunflower oil.
13. The method of any one of numbered paragraphs 10 to 12, wherein the foodstuff is wine.
14. The method of any one of the preceding numbered paragraphs wherein the contaminants are selected from pesticides, fungicides, herbicides, phenolics, a by-product of the metabolism of yeasts, a by-product of food processing and combinations thereof.
15. The method of numbered paragraph 14, wherein the contaminants are selected from fenhexamid, iprodione, 4-ethyl guaiacol, 4-ethyl phenol and combinations thereof.
16. The method of any preceding numbered paragraph, wherein in step b) the alkaline earth metal silicate is slurried with the liquid to be treated.
17. A filtered liquid obtainable from the method of any one of numbered paragraphs 1 to 16.
18. Use of the method of treating liquids according to any one of numbered paragraphs 1 to 16 in a wine production process.
19. The use of numbered paragraph 18, wherein the method of treating liquids is carried out during the clarification step.
20. The use of numbered paragraphs 18 or 19 to reduce contaminants associated with Brettanomyces yeast.
21. The use according to any one of numbered paragraphs 18 to 20 to reduce the amount of contaminants to less than 0.6 mg of contaminants per litre of wine.
22. A filter aid comprising an alkaline earth metal silicate as defined in any one of numbered paragraphs 1 to 6.

### Examples

The method comprising alkaline earth metal silicates according to the present invention were compared to alkaline earth metal silicates that were either natural and/or have a BET surface area of less than 20 m²/g.

The alkaline base metal silicate according to the invention used in the follow examples is a synthetic magnesium silicate with a d₅₀ of 6.82 μm and a BET surface area of 180 m²/g (Ex 1). As comparative examples the following were used:
Comp Ex 1: a microcrystalline surface treated talc with a d₅₀ of 1.9 μm and a BET surface area of 15 m²/g;
Comp Ex 2: a high aspect ratio talc with a d₅₀ of 1.2 μm and a BET surface area of 22 m²/g; and
Comp Ex 3: a high aspect ratio talc with a d₅₀ of 3.7 μm and a BET surface area of 6.5 m²/g.

The removal of contaminants from model wine and laboratory fermented red wine were examined using the following method.

The model wine was 10% by volume of industrial grade methylated spirits (98.99% (w/w) total alcohols, BDH Limited, Poole, UK) in distilled water, herein the pH was adjusted to 3.5 using 0.1 M HCl.

The laboratory fermented red wine used was a Cabernet Sauvignon grape concentrate, which was fermented in house using the Wineworks Premium Carbernet Sauvignon Red Wine Kit′ (Love Brewing Limited, Chesterfield, UK). This was made following the instructions provided but without the fining step which left the wine relatively turbid. The final product had a pH of 3.20 and was roughly 10% alcohol by volume, measured by changes in specific gravity.

A predetermined amount of contaminants were added to the wine samples tested. The Fluka brand of fenhexamid was purchased from Sigma-Aldrich (Dorset UK) and LGC (Teddington UK), and iprodione was purchased from Sigma-Aldrich (Dorset, UK) and 4-ethyl guaiacol was purchased from Sigma-Aldrich (Dorset, UK).

### Fenhexamid Adsorption

### Model Wine (A)

20 mL of model wine (10% by volume of methylated spirits in distilled water, pH adjusted to 3.5 using 0.1M HCl) containing 10 mg L⁻¹ (3.3×10⁻⁵ M) fenhexamid was added to 200 mg aliquots of alkaline earth metal silicate. The sample was shaken for 3 hours and then filtered through a 0.45 μm polytetrafluoroethylene (PTFE) membrane filters and scanned using the UV-vis spectrophotometer from 190-300 nm. A sample as described above without fenhexamid used as a reference. The assay was calibrated with standard fenhexamid solutions between 10 and 0.3 mg L⁻¹ and the R² values of these calibration was never below 0.9975.

The fexhexamid adsorption may also be monitored using HPLC-UV (LaChrom Elite, Hitachi). A 20 μl filtered sample was injected into a Sphereclone octadecylsilane (ODS) column (4.6×250 mm, 5 μm Ø; Phenomenex) at a flow rate of 2 ml min⁻¹. The mobile phase consisted of 50:50 (v:v) acetonitrile/distilled water (with 1 g NaH₂PO₄ L⁻¹) and the UV absorption of the eluate monitored at 210 nm. Standard solutions of 10 −0.1 mg L⁻¹ of fenhexamid in model wine were injected in triplicate in order to calibrate the assay. The R² value for this calibration was at least 0.9941 and the mean retention time for fenhexamid was 5.6 minutes.

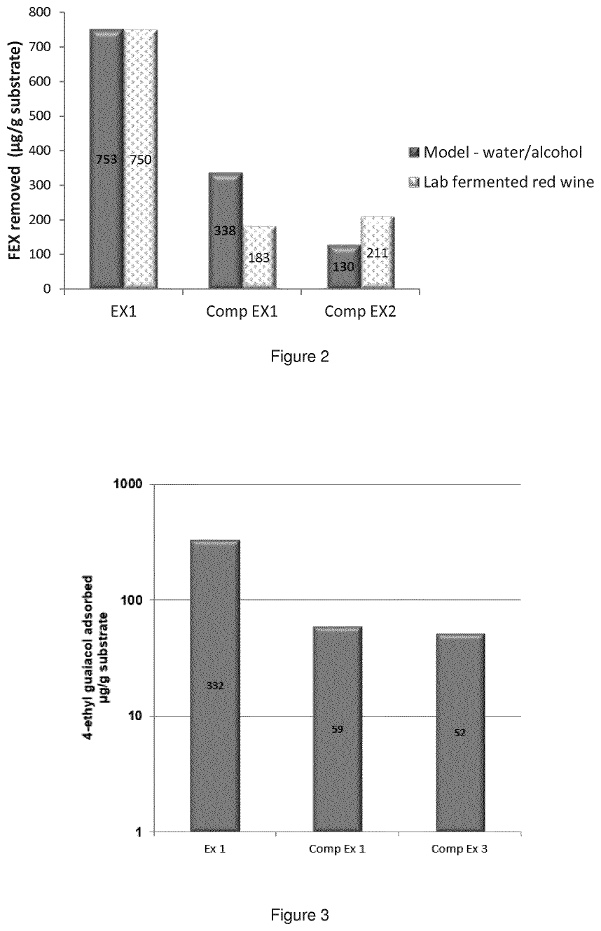

The values shown in Table 1 and FIG. 2 were measured using HPLC-UV.

### Laboratory Fermented Red Wine (B)

A 10 mg L⁻¹ solution of fenhexamid in red wine was made up by dissolving 10 mg of fenhexamid in 50 ml of methylated spirits and mixing this with 950 ml of red wine. This fenhexamid-spiked red wine was then contacted with the materials (in triplicate) in the same manner as above before being filtered through a 0.45 μm PTFE membrane filter. In order to extract the pesticide from the wine, 7 ml of the filtered wine was mixed with 7 ml of HPLC grade acetonitrile by shaking on oscillating flask shaker for 30 minutes at ambient temperature. Subsequently 1.5 g of potassium chloride was added, causing the mixture to separate into two layers, a clear upper (organic) layer with a lower (aqueous) layer which was dark red and opaque. The top layer was removed and analysed by HPLC using the same protocol as described in above.

TABLE 1

| | | Fenhexamid |
|---|---|---|
| | | removed |
| Example No. | Wine | (μg/g substrate) |
| Ex 1 | A | 753 |
| Ex 1 | B | 750 |
| Comp Ex 1 | A | 338 |
| Comp Ex 1 | B | 183 |
| Comp Ex 2 | A | 130 |
| Comp Ex 2 | B | 211 |

As may be seen from Table 1 and FIG. 2, the alkaline earth metal silicate according to the present invention (Ex 1) removed significantly more fenhexamid than when using the comparative alkaline earth metal silicates (Comp Ex 1 and Comp Ex 2). This may be attributed to the properties of the inventive method, such as the high surface area associated with Ex 1.

Furthermore, Ex 1 according to the invention performed equally well in laboratory fermented wine as with model wine. This suggest that Ex 1 is able to selectively bind fenhexamid, despite the presence of other compounds in the wine.

### 4-Ethyl Guaiacol Adsorption

A calibration curve was constructed for determination of 4-ethyl guaiacol using UV spectrophotometry. Standards of known concentration of 4-ethyl guaiacol were prepared by dissolving the substance in a solution of 90:10 distilled water:methylated spirits adjusted to pH 3.5 with 0.1M HCl (model wine A) to give concentrations within the range of 0.5 to 10 mg L⁻¹. The UV absorbance of the solutions at 198 nm was recorded and plotted against concentration. Tests of the 4-ethyl guaiacol adsorption capacity of various substrates were made (in triplicate) by weighing 200 mg of candidate adsorbent and adding to 20 mls of 10 mg/L 4-ethyl guaiacol in the model wine containing 10 mg L⁻¹ of 4-ethyl guaiacol. The mixture was shaken for 3 hours then the adsorbent particles were removed by filtration at 0.45 μm (PTFE syringe filter). UV absorbance of the filtrate was determined at 198 nm and the concentration of 4-ethyl guaiacol calculated from the calibration curve.

TABLE 2

| | | 4-Ethyl guaiacol |
|---|---|---|
| | | removed |
| Example No. | Wine | (μg/g substrate) |
| Ex. 1 | A | 332 |
| Comp Ex 1 | A | 59 |
| Comp Ex 3 | A | 52 |

As may be seen from Table 2 and FIG. 3, the alkaline earth metal silicate according to the present invention (Ex 1) removed significantly more 4-ethyl guaiacol than when using the comparative alkaline earth metal silicates (Comp Ex 1 and Comp Ex 3).

### Fenhexamid and Iprodione Adsorption

20 mL of model wine (10% by volume of methylated spirits in distilled water, pH adjusted to 3.5 using 0.1M HCl) containing 10 mg L⁻¹ (3.3×10⁻⁵ M) fenhexamid was added to 200 mg aliquots of alkaline earth metal silicate. The sample was shaken for 3 hours and then filtered through a 0.45 μm polytetrafluoroethylene (PTFE) membrane filters and scanned using the UV-vis spectrophotometer from 190-300 nm. A sample as described above without fenhexamid or iprodione used as a reference. The assay was calibrated with standard fenhexamid solutions between 10 and 0.3 mg L⁻¹ and the R² values of these calibration was never below 0.9975. The assay was calibrated with standard iprodione solutions between 10 and 0.3 mg L⁻¹ and the R² values of these calibration was never below 0.9975.

The fexhexamid and iprodione adsorption may also be monitored using HPLC-UV (LaChrom Elite, Hitachi). A 20 μl filtered sample was injected into a Sphereclone octadecylsilane (ODS) column (4.6×250 mm, 5 μm Ø; Phenomenex) at a flow rate of 2 ml min⁻¹. The mobile phase consisted of 50:50 (v:v) acetonitrile/distilled water (with 1 g NaH₂PO₄ L⁻¹) and the UV absorption of the eluate monitored at 210 nm. Standard solutions of 10-0.1 mg L⁻¹ of fenhexamid in model wine were injected in triplicate in order to calibrate the assay. The R² value for this calibration was at least 0.9941 and the mean retention time for fenhexamid was 5.6 minutes. Standard solutions of 10 −0.1 mg L⁻¹ of iprodione in model wine were injected in triplicate in order to calibrate the assay. The R² value for this calibration was at least 0.992 and the mean retention time for iprodione was 7.1 minutes.

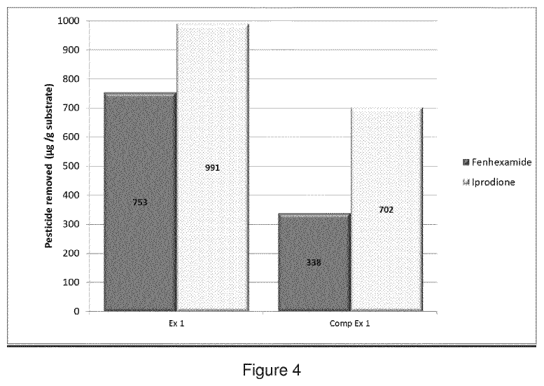

The values shown in Table 3 and FIG. 4 were measured using HPLC-UV.

TABLE 3

| | | fenhexamid | iprodione |
|---|---|---|---|
| | | removed | removed |
| Example No. | Wine | (μg/g substrate) | (μg/g substrate) |
| Ex. 1 | A | 753 | 991 |
| Comp Ex 1 | A | 338 | 702 |

As may be seen from Table 3 and FIG. 4, the alkaline earth metal silicate according to the present invention (Ex 1) removed significantly more fenhexamid and iprodione than when using the comparative alkaline earth metal silicate (Comp Ex 1).

1. A method of treating liquids to reduce contaminants comprising the steps of
(a) providing a liquid to be treated, wherein the liquid contains contaminants,
(b) contacting the liquid of step a) with an alkaline earth metal silicate, and
(c) filtering the liquid of step b) to yield a filtered liquid, wherein the alkaline earth metal silicate is a synthetic alkaline earth metal silicate, and wherein the contaminants are selected from pesticides, fungicides, herbicides, phenolics, a by-product of the metabolism of yeasts, a by-product of food processing and combinations thereof.

2. The method of claim 1, wherein the alkaline earth metal silicate is selected from synthetic magnesium silicates and synthetic calcium silicates.

3. The method of claim 2, wherein the alkaline earth metal silicate has a BET surface area in the range of 20 to 500 m<2>/g.

4. A method of treating liquids to reduce contaminants comprising the steps of
a) providing a liquid to be treated, wherein the liquid contains contaminants,
b) contacting the liquid of step a) with an alkaline earth metal silicate, and
c) filtering the liquid of step b) to yield a filtered liquid,
wherein the alkaline earth metal silicate has a BET surface area in the range of 20 to 500 m<2>/g, and wherein the contaminants are selected from pesticides, fungicides, herbicides, phenolics, a by-product of the metabolism of yeasts, a byproduct of food processing and combinations thereof.

5. The method of claim 1, wherein the alkaline earth metal silicate is a particulate.

6. The method of claim 1, wherein the alkaline earth metal silicate has a median particle size, dso, in the range 1 to 20μηη of as measured using a Microtrac X100 laser particle size analyzer.

7. The method of claim 1, wherein the alkaline earth metal silicate is used in a range of about 0.1 to about 20 g per litre of liquid to be treated.

8. The method of claim 1, wherein the amount of contaminants in the filtered liquid is less than in the liquid to be treated, preferably wherein the amount of contaminants is reduced by between 5% (w/v) and 95% (w/v).

9. The method of claim 1, wherein the liquid to be treated is a foodstuff such as a beverage or edible oil selected from wine, beer, spirits, fruit juices, vegetable juice olive oil, palm oil, peanut oil, coconut oil, cottonseed oil, corn oil, palm oil, rapeseed oil, sesame oil, soybean oil and sunflower oil.

10. The method of claim 9, wherein the foodstuff is wine.

11. The method of claim 1, wherein the contaminants are selected from fenhexamid, iprodione, 4-ethyl guaiacol, 4-ethyl phenol and combinations thereof.

12. The method of claim 1, wherein in step b) the alkaline earth metal silicate is slurried with the liquid to be treated.

13. A filtered liquid obtainable from the method of claim 1.

14. A production process comprising the method of treating liquids according to claim 1, wherein the production process is a wine production process.

15. The production process of claim 14, wherein the method of treating liquids is carried out during the clarification step.

16. The method of claim 5, wherein the alkaline earth metal silicate has a median particle size, dso, in the range 1 to 20μηη of as measured using a Microtrac X100 laser particle size analyzer.

17. The method of claim 16, wherein the alkaline earth metal silicate is used in a range of about 0.1 to about 20 g per litre of liquid to be treated.

18. The method of claim 17, wherein the amount of contaminants in the filtered liquid is less than in the liquid to be treated, preferably wherein the amount of contaminants is reduced by between 5% (w/v) and 95% (w/v).

19. The method of claim 18, wherein in step b) the alkaline earth metal silicate is slurried with the liquid to be treated.

20. The method of claim 19, wherein the alkaline earth metal silicate has a BET surface area in the range of 20 to 500 m<2>/g.
